(19) United States
(12) Patent Application Publication
(10) Pub. No.: US 2014/0192038 A1
(43) Pub. Date: Jul. 10, 2014

(54) OLED PIXEL DRIVING CIRCUIT

(71) Applicant: EverDisplay Optronics (Shanghai) Limited, Shanghai (CN)

(72) Inventors: Yongliang Qin, Shanghai (CN); Jr Hong Chen, Shanghai (CN); Chu Wan Huang, Shanghai (CN)

(73) Assignee: EverDisplay Optronics (Shanghai) Limited, Shanghai (CN)

(21) Appl. No.: 14/151,413

(22) Filed: Jan. 9, 2014

(30) Foreign Application Priority Data
Jan. 10, 2013 (CN) 201310009175.4

(51) Int. Cl. G09G 3/32

(52) U.S. Cl. CPC G09G 3/3258
USPC 345/212; 345/76

(57) ABSTRACT

The present invention relates to an OLED pixel driving circuit which has a data input unit for sending out controlling signals, a voltage storage unit for storing voltages from a first power source, a driving unit for receiving the controlling signals from the data input unit to selectively activate the voltage storage unit, a second power source providing a voltage to be stored in the voltage storage unit; and a switch connected to the second power source to offset potential loss of the first power source from the voltage stored in the voltage storage unit. The compensation circuit can not only compensate the non-uniformity of the threshold voltage but also eliminate the non-uniformity of the OLED display caused by the power IR drop, so that the effect of display of the OLED are maximally improved.

### CROSS-REFERENCE TO RELATED APPLICATIONS

The present application claims priority to and the benefit of Chinese Patent Application No. CN201310009175.4, filed on Jan. 10, 2013. The entire content of which is incorporated herein by reference.

### BACKGROUND

1. Field of the Invention

The present invention generally relates to a circuit, more particularly, to an OLED pixel driving circuit.

2. Description of the Related Art

With Regards to technology of LTPS (Low Temperature Poly-Silicon), it was developed by Japanese and North American technology enterprises in order to reduce the power consumption of notebook-PC display screen and to make the notebook-PC lighter and thinner. The technology of LTPS entered the trial stage in about mid 90's. The new generation OLED (Organic Light Emitting Diode) panel derived from LTPS also formally entered the practical stage in 1998. The advantage of OLED is ultra-thin, lightweight, low power consumption and the characteristics of self-luminosity Therefore OLED can provide brighter colors and more distinct images. It is more important that the cost thereof is almost ⅓ of that of LCD (Liquid Crystal Display) panel. AM-OLED (Active Matrix/Organic Light Emitting Diode) has fast response time, high contrast, wide viewing angle etc. in comparison with the traditional LCD panel.

Traditional AM-OLED uses a 2T1C driving circuit, which includes a switching transistor, a driving transistor and a storage capacitor. When the scanning line is valid, the switching transistor is turned on and the data signal is stored in the storage capacitor. The voltage signal stored in the storage capacitor determines on-off status of the driving transistor and converts the input data voltage signal into a current signal, whereas the OLED requires light emitting diodes to display different gray scales. As result of the laser annealing technique applied in the LTPS process, the threshold voltage (Vth) of the transistors has a defect of non-uniformity, whereby there is a large difference between threshold voltages (Vth) among driving transistors. In low gray-scale images, the size of non-uniformity area of LTPS AM-OLED with 2T1C driving circuit in the same direction of a small range occupies 30% to 40% of the whole area, even if the size of the different areas between adjacent transistors may also reach 20% of the whole area. At the same time, if the pixel power supply line of LTPS transistor is long enough, the pixel circuit power will generate a big IR drop, which may result in a serious non-uniformity in gray-level of the AM-OLED display. In low gray-scale images, the non-uniformity rate caused by the IR drop with the same 2T1C circuit will reach more than 70% of the whole area. Therefore, the practically applied AM-OLED pixel circuit mostly eliminates the non-uniformity between short-range and long-range caused by threshold voltage (Vth) and the IR drop through increasing circuits to compensate the threshold voltage (Vth) and IR drop.

FIG. 1 is a common LTPS AM-OLED 2T1C pixel driving circuit. T1 is a switching transistor, T2 is a driving transistor, and C1 is a storage capacitor. The storage capacitor C1 controls the current flow through the driving transistor T2 to complete the OLED gray-scale display. However, such circuit can not compensate the influence of the non-uniformity display of the AM-OLED caused by the non-uniformity of the transistor threshold voltage (Vth) and the IR power drop.

In order to solve the problem of non-uniformity of threshold voltage (Vth) of LTPS transistor, the related art proposed a 4T2C compensation circuit, which compensates the non-uniformity of AM-OLED display caused by LTPS transistor threshold voltage (Vth) effectively. FIG. 2 is a conventional pixel circuit structure of the 4T2C compensation circuit and FIG. 3 is a clock diagram for driving the circuit. As illustrated in FIG. 3, three control lines and a data line are required. Extra time is needed for the pixel circuit to compensate the threshold voltage (Vth) during display. The controlling lines in the adjacent pixel rows cannot be shared and more lines are required in each independent row, which affects the layout inside a panel. This conventional driving circuit does not meet the requirements to compensate the IR drop and thus a complicated clock structure is used.

### SUMMARY OF THE INVENTION

The embodiments of the present invention provides an OLED pixel driving circuit to compensate the threshold voltage (Vth) and the IR drop, which improves the influence of non-uniformity in the AM-OLED display, which is caused by the Vth drift and the IR power drop. Meanwhile, a simple driving timing is applied to increase the AM-OLED light-emitting time in every frame, whereby the brightness of the AM-OLED is improved and the OLED service life is increased.

In a compensation circuit having a data input unit for sending out controlling signals, a voltage storage unit for storing voltages from a first power source and a driving unit for receiving the controlling signals from the data input unit to selectively activate the voltage storage unit, wherein the improvement comprises:

a second power source providing a voltage to be stored in the voltage storage unit; and

a switch connected to the second power source to offset potential loss of the first power source from the voltage stored in the voltage storage unit.

According to one embodiment of the disclosure, wherein the driving unit comprises a first electrode, a second electrode and a control terminal;

current flowing through the first electrode and the second electrode of the driving unit is controlled according to variation of the voltage loaded on the control terminal;

one end of the voltage storage unit is connected to the control terminal of the driving element to form a coupling point;

the other end of the voltage storage unit is connected to the first electrode to form an input point;

the second electrode of the driving unit forms an output point;

a coupling element is coupled to the coupling point;

the first power input is connected to the input point;

a synchronous switch is connected between the output point and the coupling point and controlled by the controlling signals.

According to one embodiment of the disclosure, further comprising a light-emitting working unit controllably coupled to the output point.

According to one embodiment of the disclosure, wherein the light-emitting working unit further comprises a light-emitting element and a control element;

the light-emitting element is connected to the output point through the control element;

the control element is a control switch which is controlled by level fluctuation.

According to one embodiment of the disclosure, further comprising a voltage input unit controllably connected to the coupling element for sending data voltage to the driving unit.

According to one embodiment of the disclosure, wherein the voltage input unit is connected to the coupling element by a data switch.

According to one embodiment of the disclosure, wherein the data switch is a switch transistor which is formed by a thin film transistor.

According to one embodiment of the disclosure, wherein the data switch is a PMOS switch transistor;

the gate of the PMOS switch transistor is connected to the data input unit.

According to one embodiment of the disclosure, wherein the driving unit is a driving transistor.

According to one embodiment of the disclosure, wherein the voltage storage unit is a non-polar capacitor.

According to one embodiment of the disclosure, wherein the switch is a switch transistor which is formed by a thin film transistor.

According to one embodiment of the disclosure, wherein the switch is a PMOS switch transistor;

the gate of the PMOS switch transistor is connected to the data input unit.

According to one embodiment of the disclosure, wherein the coupling element is a non-polar capacitor.

According to one embodiment of the disclosure, wherein the synchronous switch is a switch transistor which is formed by a thin film transistor.

According to one embodiment of the disclosure, wherein the synchronous switch is a PMOS switch transistor;

the gate of the PMOS switch transistor is connected to the data input unit.

According to one embodiment of the disclosure, wherein the light-emitting element is an organic light-emitting element.

According to one embodiment of the disclosure, wherein the control switch is a switch transistor which is formed by a thin film transistor.

According to one embodiment of the disclosure, wherein the control switch is a PMOS switch transistor;

the gate of the PMOS switch is connected to a level input for controlling light-emitting working.

In Comparison with the existing pixel circuit, the advantages of the present invention are as follows:

(1) Both Vth drift and IR Drop are compensated, whereby the influence on the I_{OLED} caused by the Vth and the power supply IR Drop can be reduced to about 1.6% to 3%;

(2) The non-uniformity in the AM-OLED display caused by the Vth shift and the power IR drop are effectively improved;

(3) The influence on the display uniformity AM-OLED due to the power IR drop is eliminated, thus the display effect and the service life of display are enhanced. At the same time, the present invention simplifies the driving timing of pixel circuit; it improves the layout of the flat-screen and the anti-jamming performance; and the light-emitting time of AM-OLED in each frame is increased, which will help to improve the brightness of the AM-OLED and increase the service life of OLED.

### BRIEF DESCRIPTIONS OF THE DRAWINGS

The embodiments of the invention are illustrated by way of example, and not by way of limitation, in the figures of the accompanying drawings:

FIG. 1 shows a circuit diagram of a 2T1C driver for OLED;

FIG. 2 shows a circuit diagram of a 4T2C driver for OLED;

FIG. 3 shows a clock diagram of 4T2C driver for OLED in FIG. 2;

FIG. 4 shows a block diagram of a driving unit for OLED, in accordance with an exemplary embodiment;

FIG. 5 is a block diagram depicting a driving unit configured with a compensating unit for OLED in accordance with another exemplary embodiment;

FIG. 6 is a circuit diagram depicting a driving component configured with a compensating unit for OLED in accordance with another exemplary embodiment;

FIG. 7 shows a clock diagram of a driving unit configured with a compensating module for OLED, in accordance with various embodiments.

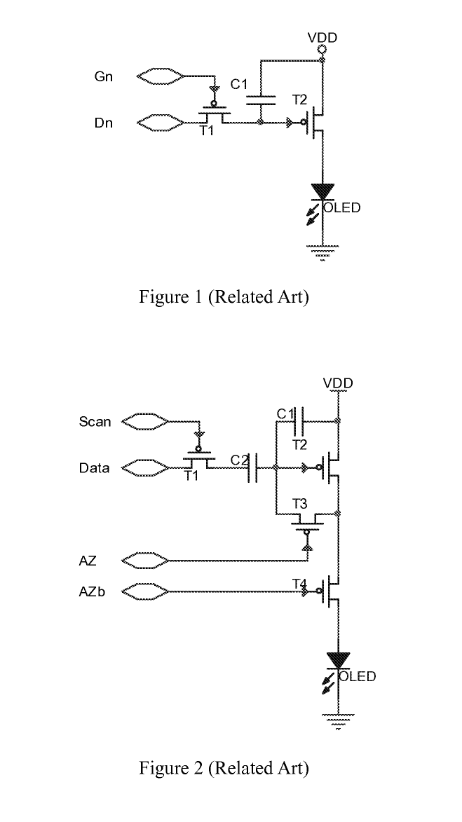

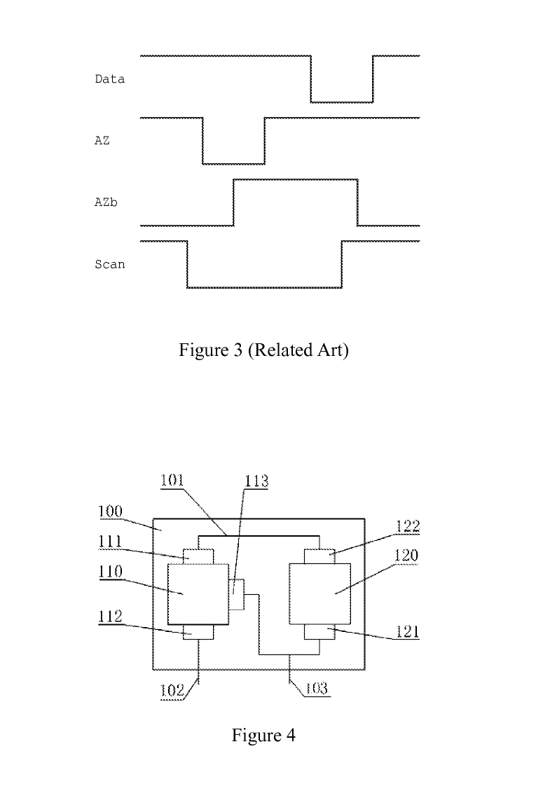

### DESCRIPTION OF SOME EMBODIMENTS

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximately estimated, meaning that the term “around”, “about” or “approximately” can be inferred if not expressly stated.

As used herein, the term “plurality” means a number greater than one.

Examples of a pixel drive circuit are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

FIG. 4 shows a block diagram of a driving component for OLED, in accordance with an exemplary embodiment. A driving component 100 comprises a driving unit 110 and a voltage storage unit 120. The driving unit 110 has a first electrode 111, a second electrode 112 and a control terminal 113. The current flowing through the first electrode 111 and the second electrode 112 of the driving unit 110 depends on the voltage at the control terminal 113. The second electrode 112 of the driving unit 110 is connected to an output point 102 of the driving component 100 for driving an OLED pixel.

The voltage storage unit 120 has a first terminal 121 and a second terminal 122. The first terminal 121 of the voltage storage unit 120 is connected to the control terminal 113 of the driving unit 110, which forms a coupling point 103 of the driving component 100. A coupling element is coupled to the coupling point. The second terminal 122 of the voltage storage unit 120 is connected to the first electrode 111 of the driving unit 110, which forms an input point 101 of the driving component 100.

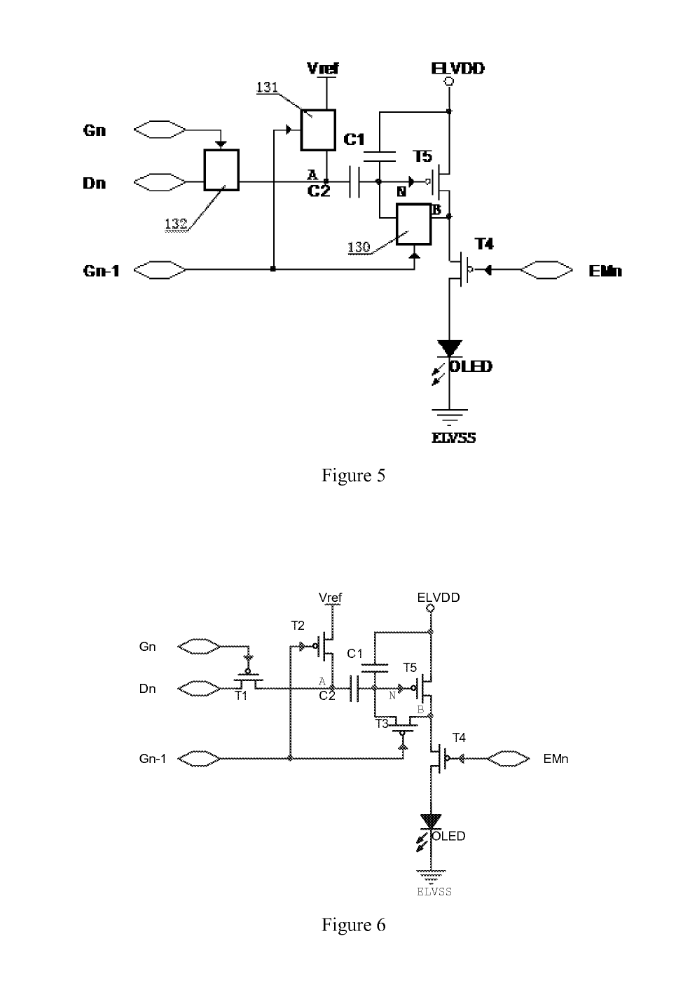

As shown in FIGS. 4 to 5, the compensation circuit in the embodiment of the present invention, which has a data input unit Gn-1 for sending out controlling signals, a voltage storage unit 120 for storing voltages from a first power source ELVDD, a driving unit 110 for receiving the controlling signals from the data input unit Gn-1 to selectively activate the voltage storage unit 120, a second power source Vref providing a voltage to be stored in the voltage storage unit 120, and a switch 131 connected to the second power source Vref to offset potential loss of the first power source LEVDD from the voltage stored in the voltage storage unit 120.

The compensation circuit in the embodiment of the present invention comprises a driving component, a compensation unit, a voltage input unit, a light-emitting working unit, a data signal input, a first power source and a plurality of control level inputs. The compensation circuit works in three stages: compensation stage, data input stage and light-emitting working stage. These three stages can be cyclically in sequence. During the compensation stage, the voltage input unit 132 and the light-emitting working unit are off, and the compensation unit makes the first power source coupled to voltage storage unit 120 by driving unit 110.

Regarding the compensation circuit in the present invention, when it is in the data input stage, the light-emitting working unit are off, and the voltage input unit 132 makes the data signal input coupled to the voltage storage unit 120; when it is in the light-emitting working stage, the voltage input unit 132 is off, and the driving component utilizes the voltage stored in the voltage storage unit 120 to control the driving unit to drive the light-emitting working unit to utilize the first power source to emit light.

The compensation unit comprises a synchronous switch 130 and a switch 131. Each of the synchronous switch 130 and the switch 131 has a first terminal, a second terminal and a control terminal. The driving unit T5 has a first terminal, a second terminal and a control terminal. The voltage storage unit 120 is a non-polar capacitor C1 and a non-polar capacitor C2 is a coupling element. Each of the voltage storage unit C1 and the coupling element C2 has a first terminal and a second terminal. The control terminal of the synchronous switch 130 is connected to the first terminal of the voltage storage unit C1, the driving terminal of the driving unit T5 and the first terminal of the coupling element C2 at the coupling point. The second terminal of the voltage storage unit C1 is connected to the first terminal of the driving unit T5. The second terminal of the driving unit T5 is connected to the light-emitting working unit through the synchronous switch 130. The synchronous switch 130 can be a switch such as thin film transistor. The switch 131 can also be a thin film transistor. The on-off status of the synchronous switch 130 and the switch 131 depends on the controlling signal at each control terminal.

The voltage input unit 132 can be a data switch T1 which is controlled by the level fluctuation and applied to connect and disconnect to the data signal input Dn with the coupling element of the coupling point N.

The light-emitting working unit comprises a light-emitting element and a control element. One end of the light-emitting element is connected to the output point B of the driving component through the control element, and the other end of the light-emitting element is connected to the ground. The control element can be a control switch which is controlled by the level fluctuation and applied to connect and disconnect the light-emitting element to the output point B of the driving component.

FIG. 6 is a circuit diagram depicting a driving component configured with a compensating unit for OLED in accordance with another exemplary embodiment. The coupling element can be a non-polar capacitor C2. The driving unit can be a driving transistor. The voltage storage unit 120 can be a non-polar capacitor C1. The data switch is a switch transistor T1 which is formed from a thin film transistor. The light-emitting element can be an organic light-emitting element (OLED). The control switch is a switch transistor T4 such as a thin film transistor. The capacitors, C1 and C2, both can be parallel-plate capacitors. The driving transistor T5 may be a thin film transistor. The synchronous switch is a switch transistor T3 formed from a thin film transistor. The switch is a switch transistor T2 formed from a thin film transistor.

The data switch can be a PMOS (Positive channel Metal Oxide Semiconductor) switch transistor, a plurality of control level inputs comprise level inputs for controlling data input, the gate of the PMOS switch transistor is connected to the level input for controlling data input.

The control switch can be a PMOS switch transistor. The control level inputs comprise level inputs for controlling light-emitting working. The gate of the PMOS switch is connected to the level input for controlling light-emitting working.

The synchronous switch can be a PMOS switch transistor. The gate of the first PMOS switch transistor is connected to the data input unit Gn-1. The switch can be a switch transistor T2, which is connected between the second power source Vref and the coupling element C2 of the coupling point N, and the on-off status of the switch is controlled by the level fluctuation. The switch T2 is a PMOS switch transistor which is a thin film transistor. The gate of the second PMOS switch transistor is connected to the data input unit Gn-1.

In the compensation stage, EMn is switched to high level, the switch transistor T4 turns off, at this time, the display of the OLED turns off; the first power source ELVDD utilizes the driving transistor T5 to make the value of the voltage at the coupling point N in FIG. 6 reach a value which is acquired by using the first power source ELVDD minus the threshold voltage Vth, and the voltage value is stored in the voltage storage capacitor C1. At this time, Gn-1 is a low level. The switch transistor T2 and the switch transistor T3 are on so that the point A is changed to Vref. At this time, Gn-1 is low level, the light-emitting control line EMn is high level, and Gn is also high level; the second power source Vref is chosen the suitable voltage, the coupling of the C2 is utilized to assist the driving transistor T5 be on in the compensation stage.

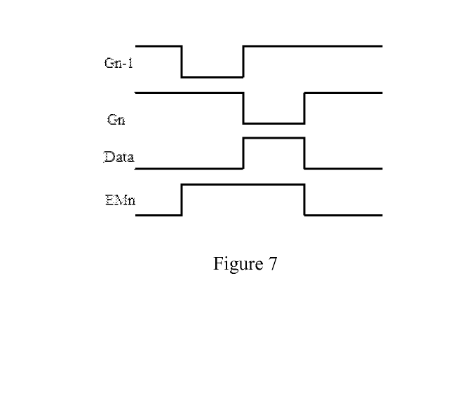

Refer to FIG. 6 and FIG. 7, in the data inputting stage, the voltage at point A is changed into the level of the data line Dn. The level of the data line Dn is coupled to the coupling point N by the coupling capacitor C2. Gn-1 is changed to high level, and the switch transistor T2 and the switch transistor T3 are switched off; Gn is changed to low level, T1 is on, and the data line Dn is added to the point A by the switch transistor T1. At this time, the scanning line Gn-1 is high level, light-emitting control line Emn will be high level, the scanning line Gn will beat low level, and the data line Dn will be high level. The level of the point A is changed from Vref into VDn, and the amount of the voltage change is ΔVA=Vref−VDn . The data is coupled to the coupling point N by C2, and the influence that Dn makes to the coupling point N is:

$$Δ VN = ( Vref - VDn ) \frac{C 2}{C 1 + C 2}$$

Hence, at this time, the voltage of the coupling point N is:

$$VN = ELVDD - Vth + ( Vref - VDn ) \frac{C 2}{C 1 + C 2}$$

In the display stage, the voltage of the coupling point N is hold by the storage capacitor C1, the voltage of the data input stage is kept to be invariable. The scanning line Gn is at high level, the light-emitting control line EMn is at low level, and the scanning line Gn is at high level. When Gn is changed to high level, the data input channel will be closed; the switch transistor T4 will be on, and the voltage of the coupling point N will be hold by the storage capacitor C1, and the level in the data input stage will be kept to be invariable. Therefore, the voltage Vgs which is between the gate of the driving transistor T5 and the electrode is:

$$Vgs = - ( Vref - VDn ) \frac{C 2}{C 1 + C 2} + Vth$$

The current flowing through T5 is decided by the following formula:

$$I = \frac{1}{2} Cox \frac{μ W}{L} ( Vgs - Vth ) ,$$

so the current I_{OLED} can be figured out as follows:

$${I}_{OLED} = \frac{1}{2} Cox {\frac{μ W}{L} [ ( Vref - VDn ) \frac{C 2}{C 1 + C 2} ]}^{2}$$

Wherein Cox denotes the channel capacitance in a unit area of the driving transistor T5; μ denotes the channel mobility; W denotes the channel width; L denotes the channel length.

In the display stage, as the stray capacitance of the switch transistor T1 C_{Ds} is much smaller than C2, a majority of the interference which comes from the stray capacitance C_{DS} of the switch transistor T1 can be eliminated by the series connection of C1 and C2.

The introduction of the level Vref is based on the following two points to eliminate the influence brought by the line impedance:

1. The Vref at the input port of the panel is the second power source Vref plane of the data line Dn, and the Vref in the pixel circuit also works as the second power source Vref plane of the data line Dn.

2. Vref is just the second power source plane, which does not need to generate the current for the OLED to emit light. Hence, the current flowing through the Vref line is almost zero and the voltage drop of the IR in the Vref line is tiny, thus the effect is nearly non-existed.

In another embodiment, the switch transistor T3 also can be a MOSFET (Metal-Oxide-Semiconductor Field-Effect Transistor) with double gate structure. The MOSFET with double gate structure is a structure which reduces the stray parameter to increase the switching frequency. The double gate structure applied here can efficiently reduce the leakage current and the voltage variation at the coupling point N in the display stage.

In conclusion, the compensation circuit of the present invention can not only compensate the non-uniformity of the threshold voltage (Vth) but also eliminate the non-uniformity of the OLED display caused by the power IR drop, so that the effect of display of the OLED is maximally improved. The effect of display of the OLED and the service life of the OLED display are enhanced. Meanwhile, the driving timing of the pixel circuit is also simplified, and the layout of the flat-screen and the performance of anti-interference are also improved.

Although various embodiments have been given with the above descriptions and the figures, they should be appreciated that they are only the examples. It is obvious for the skilled in the art to make varieties of changes and modifications after reading the above descriptions, which should not be deemed as exceeding the scope of this invention. All the other changes based on the spirit of this invention may also be covered in this invention.

What is claimed is:

1. In a compensation circuit having a data input unit for sending out controlling signals, a voltage storage unit for storing voltages from a first power source and a driving unit for receiving the controlling signals from the data input unit to selectively activate the voltage storage unit, wherein the improvement comprises:
a second power source providing a voltage to be stored in the voltage storage unit; and
a switch connected to the second power source to offset potential loss of the first power source from the voltage stored in the voltage storage unit.

2. The compensation circuit according to claim 1, wherein the driving unit comprises a first electrode, a second electrode and a control terminal;
current flowing through the first electrode and the second electrode of the driving unit is controlled according to variation of the voltage loaded on the control terminal;
one end of the voltage storage unit is connected to the control terminal of the driving element to form a coupling point;
the other end of the voltage storage unit is connected to the first electrode to form an input point;
the second electrode of the driving unit forms an output point;
a coupling element is coupled to the coupling point;
the first power input is connected to the input point;
a synchronous switch is connected between the output point and the coupling point and controlled by the controlling signals.

3. The compensation circuit according to claim 2, further comprising a light-emitting working unit controllably coupled to the output point.

4. The compensation circuit according to claim 3, wherein the light-emitting working unit further comprises a light-emitting element and a control element;
the light-emitting element is connected to the output point through the control element;
the control element is a control switch which is controlled by level fluctuation.

5. The compensation circuit according to claim 2, further comprising a voltage input unit controllably connected to the coupling element for sending data voltage to the driving unit.

6. The compensation circuit according to claim 5, wherein the voltage input unit is connected to the coupling element by a data switch.

7. The compensation circuit according to claim 6, wherein the data switch is a switch transistor which is formed by a thin film transistor.

8. The compensation circuit according to claim 6, wherein the data switch is a PMOS switch transistor;
the gate of the PMOS switch transistor is connected to the data input unit.

9. The compensation circuit according to claim 1, wherein the driving unit is a driving transistor.

10. The compensation circuit according to claim 1, wherein the voltage storage unit is a non-polar capacitor.

11. The compensation circuit according to claim 1, wherein the switch is a switch transistor which is formed by a thin film transistor.

12. The compensation circuit according to claim 1, wherein the switch is a PMOS switch transistor;
the gate of the PMOS switch transistor is connected to the data input unit.

13. The compensation circuit according to claim 2, wherein the coupling element is a non-polar capacitor.

14. The compensation circuit according to claim 4, wherein the synchronous switch is a switch transistor which is formed by a thin film transistor.

15. The compensation circuit according to claim 2, wherein the synchronous switch is a PMOS switch transistor;
the gate of the PMOS switch transistor is connected to the data input unit.

16. The compensation circuit according to claim 4, wherein the light-emitting element is an organic light-emitting element.

17. The compensation circuit according to claim 4, wherein the control switch is a switch transistor which is formed by a thin film transistor.

18. The compensation circuit according to claim 4, wherein the control switch is a PMOS switch transistor;
the gate of the PMOS switch is connected to a level input for controlling light-emitting working
